(19) United States
(12) Patent Application Publication
(10) Pub. No.: US 2007/0137450 A1
(43) Pub. Date: Jun. 21, 2007

(54) Device for positioning a workpiece to be cut and a method of using the same

(76) Inventor: Sandor Nagyszalancy, Bonny Doon, CA (US)

Correspondence Address: MCDERMOTT, WILL & EMERY LLP, 227 WEST MONROE STREET, CHICAGO, IL, 60606-5096, US

(21) Appl. No.: 11/639,489

(22) Filed: Dec. 14, 2006

(30) Foreign Application Priority Data
Dec. 15, 2005 (CN) 200510123092.3

(51) Int. Cl. B26D 1/00; B26D 7/02; B26D 5/08

(52) U.S. Cl. 83/13; 83/465; 83/471; 83/581

(57) ABSTRACT

A device for stabilizing a workpiece, i.e. a crown molding, so as to facilitate cutting angled joint surfaces which are able to be jointed together to form a corner. The device comprises a base plate, a first supporting wall, a second supporting wall and an adjusting device disposed between the base plate and the second supporting wall for adjusting a position of the second supporting wall on a base plane. A method of using the stabilizing device comprises the following steps: to place a stabilizing device on a miter saw, to abut a first supporting wall or a first side edge of the base plate against a fence of the miter saw; after a first cutting is completed, to abut a second supporting wall or a second side edge of the base plate against the fence to perform a second cutting.

### CROSS-REFERENCE TO RELATED APPLICATIONS

This application claims priority to Chinese Application No. 200510123092.3 filed Dec. 15, 2005, the entire disclosure of which is incorporated herein by reference. Priority to this application is claimed under 35 U.S.C. 119, 120 and/or 365.

### FEDERALLY SPONSORED RESEARCH OR DEVELOPMENT

Not Applicable.

### TECHNICAL FIELD

The present invention relates to a device used for positioning and stabilizing a workpiece thereby for precisely cutting the workpiece with a cutting tool, and also relates to a method of using the stabilizing device.

### BACKGROUND OF THE INVENTION

A crown molding is often used to add detail around the perimeter of a room's ceiling, around the tops of cabinets, or to accent lighting fixtures and skylights. A crown molding is often mounted at a certain angle to the plane to be decorated, as shown in FIG. 1. The decorative frame is formed by joining one crown molding 10 to another. As there are corners on the walls, the decorative frames comprise outside-corner joints 12 and inside-corner joints 14. FIG. 2 shows a joint of crown moldings 10, which respectively comprises a right outside-corner joint surface 122 and a left outside-corner joint surface 124 joined together to form the outside-corner joint 12. FIG. 3 shows an inside-corner joint of crown moldings 10, wherein the inside-corner joint is formed by binding a right inside-corner joint surface 142 and a left inside-corner joint surface 144.

As these joints are different than an ordinary joint, the angled mating of the joint surfaces is very complicated, and a compound miter joint surface 20 is required for each crown molding 10. The compound miter joint surface inclines to multiple surfaces of the crown molding 10, as shown in FIG. 4. To obtain such a surface, a compound miter saw 30, as shown in FIG. 5, is usually required. Before cutting, it is required to turn a turntable 32 to a predetermined miter angle, and to adjust the cutting unit 34 so that the saw blade 36 is beveled to a predetermined angle with respect to the supporting surface 38. The cutting angles for four types of the different joint surfaces 122, 124, 142, 144 are similar in degrees, but are different in angle directions. The conventional methods of cutting various joint surfaces will be explained as follows:

To cut a left inside-corner joint surface:

1. flat lying a crown molding on the support surface of a miter saw, with the top side abutting the fence; 2. left beveling the saw blade; 3. turning the turntable to the right side; 4. saving the left end of the crown molding.

To cut a left outside-corner joint surface:

1. flat lying a crown molding on the support surface of a miter saw, with the bottom side abutting the fence; 2. left beveling the saw blade; 3. turning the turntable to the left side; 4. saving the right end of the crown molding.

To cut a right inside-corner joint surface:

1. flat lying a crown molding on the support surface of a miter saw, with the bottom side abutting the fence; 2. left beveling the saw blade; 3. turning the turntable to the left side; 4. saving the left end of the crown molding.

To cut a right outside-corner joint surface:

1. flat lying a crown molding on the support surface of a miter saw, with the top side abutting the fence; 2. left beveling the saw blade; 3. turning the turntable to the right side; 4. saving the right end of the crown molding.

It is thus not so easy for a non-skilled person to operate accurately without being confused. Therefore it's all-too-easy to accidentally make cuts at the wrong settings, and end up with joints that don't mate correctly, which also results in material wasting.

### SUMMARY OF THE INVENTION

One object of the invention is to provide a device for stabilizing a workpiece, especially for stabilizing a crown molding as mentioned hereinabove, so as to assist in an accurate cutting of joint surfaces for an outside- or inside-corner joint.

For such purpose, the stabilizing device according to the present invention comprises a base plate, which comprises a base plane, a first side edge, a second side edge, and two oblique side edges, wherein the first side edge and the second side edge of the base plate is substantially parallel and opposite to each other. A first supporting wall stands close to the first side edge of the base plate, with two ends thereof located within oblique side edges of the base plate, and the first supporting wall has a first supporting surface substantially perpendicular to the base plane. A second supporting wall stands close to the second side edge of the base plate, with two ends thereof located within the oblique side edges of the base plate, and the second supporting wall has a second supporting surface substantially perpendicular to the base plane and parallel to the first supporting surface. The first supporting surface is substantially equal to said second supporting surface in height. An adjusting device disposed between the base plate and the second supporting wall for adjusting the position of the second supporting wall on the base plane so that the second supporting wall is movable and can be fixed between the first supporting wall and the second side of base plate.

Since the distance between the first supporting surface and the second supporting surface is adjustable to fit different widths of the workpieces, various workpieces can be fixed therein. To obtain a joint surface of a crown molding, merely lean the crown molding against one of the supporting surfaces, and turn the turntable of the miter saw to a required miter angle, then the saw blade may cut the molding vertically, without having to be beveled. In addition, as the first supporting surface is substantially equal to said second supporting surface in height, the workpiece may lean against either of the supporting surfaces. Furthermore, as the first side edge of the base plate is substantially parallel to the second one of the base plate, either the first side edge or the second side edge may abut the fence of the miter saw. Consequently, it is possible to perform the cutting of the four types of the joint surfaces on one side of the saw blade, thereby facilitating a left or right hand operation of an operator. These advantages will be more apparent upon consideration of the following detailed description.

A second object of the present invention is to provide a device for stabilizing a workpiece, which enables an operator to cut required joint surfaces more simply and quickly. For this purpose there are four pairs of markings on the first supporting wall, the second supporting wall and the base plate for guiding how the workpiece should be positioned for cutting. The four pairs of markings are shown in different forms, so as to be distinct from each other. Labels are provided adjacent to the oblique side edges for indicating cutting results achievable when the workpiece being oriented according to the said four pairs of markings. Consequently, an operator can position the workpiece quickly with error rate being mostly minimized.

Still another object of the present invention is to provide a method of using the stabilizing device; said method comprises the steps listed below:

to provide a miter saw which comprises a turntable, a fence and a saw blade;

to provide a device for stabilizing a workpiece to be cut on the miter saw, with the base plate thereof sitting on the table of the miter saw and the first supporting wall or the first side edge of the base plate abutting the fence;

to provide one or more workpieces to be cut, each of which has a main surface;

to place one workpiece to be cut on the base plate between the first supporting wall and the second supporting wall, with the main plane of the workpiece inclined to the base plane;

to adjust the adjusting device to fix the workpiece between the first supporting wall and the second supporting wall;

to rotate the turntable of the miter saw so that the saw blade forms a predetermined angle with the fence, and then, to cut the workpiece with the saw blade;

to unclamp the workpiece;

to move the stabilizing device to a position where the second supporting wall or the second side edge of the base plate abuts the fence;

to place the workpiece or another workpiece on said device between the first supporting wall and the second supporting wall, with the main plane of the workpiece inclined to the base plane of said device;

to adjust the adjusting device to fix the workpiece between the first supporting wall and the second supporting wall;

to rotate the turntable of the miter saw so as to make the saw blade to form a predetermined angle with the fence, and then, to cut the workpiece with the saw blade.

The using method makes it possible that the cutting of four types of the joint surfaces can be performed on one side of the saw blade, thereby facilitating a left or right hand operation of an operator.

### BRIEF DESCRIPTION OF THE DRAWINGS

FIG. 1 is a perspective view of a decorative frame mounted between a wall and a ceiling;

FIG. 2 is a perspective view of an outside-corner joint of decorative frame showing a joint surface of a crown molding;

FIG. 3 is a perspective view of an inside-corner joint of decorative frame showing a joint surface of a crown molding;

FIG. 4 is a schematic view of a crown molding showing compound angle relationship between the joint surface and side surface of the crown molding;

FIG. 5 is a perspective view of a miter saw in a compound status;

FIG. 6 is a perspective view of one embodiment of the device for stabilizing a workpiece to be cut according to the present invention;

FIG. 7 is a top view of the stabilizing device shown in FIG. 6;

FIG. 8 is a perspective view showing the position relationship between the crown molding and the stabilizing device when a right inside-corner joint surface of the crown molding to be cut;

FIG. 9 is a perspective view showing the position relationship between the crown molding and the stabilizing device when a left outside-corner joint surface of the crown molding to be cut;

FIG. 10 is a perspective view showing the position relationship between the crown molding and the stabilizing device when a left inside-corner joint surface of the crown molding to be cut;

FIG. 11 is a perspective view showing the position relationship between the crown molding and the stabilizing device when a right outside-corner joint surface of the crown molding to be cut;

FIG. 12 is a perspective view showing one way for placing the stabilizing device and a crown molding on a miter saw;

FIG. 13 is a perspective view showing another way for placing the stabilizing device and a crown molding on a miter saw.

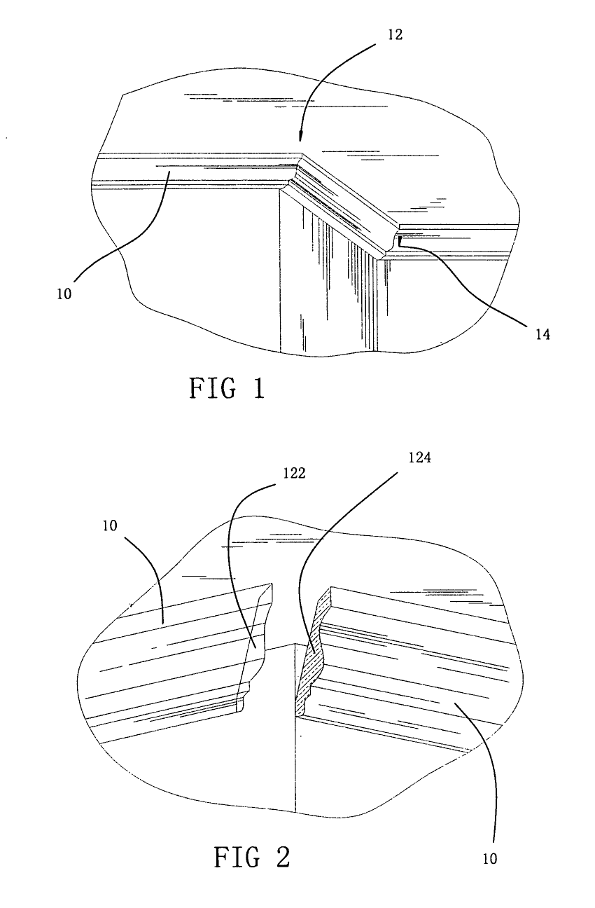

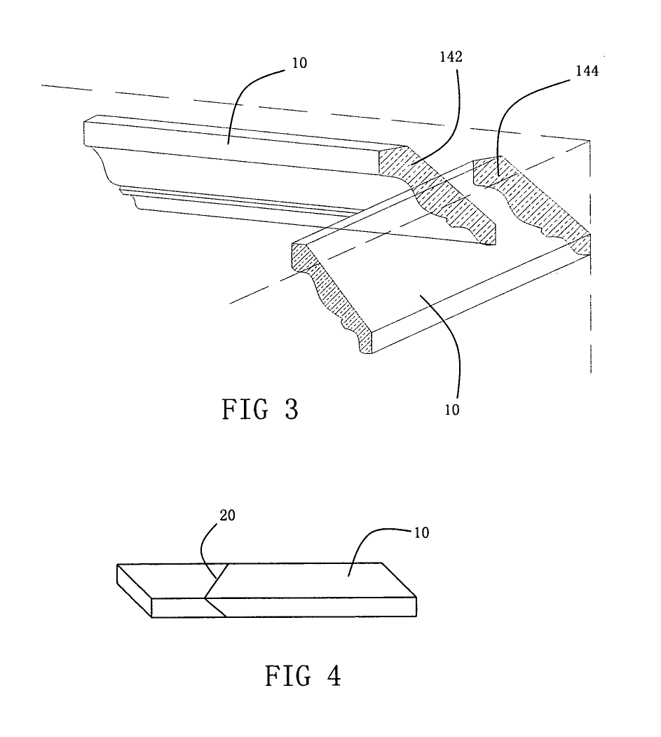

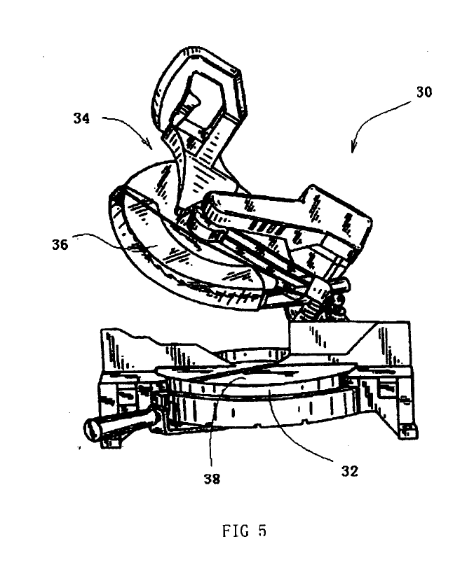

### DETAILED DESCRIPTION

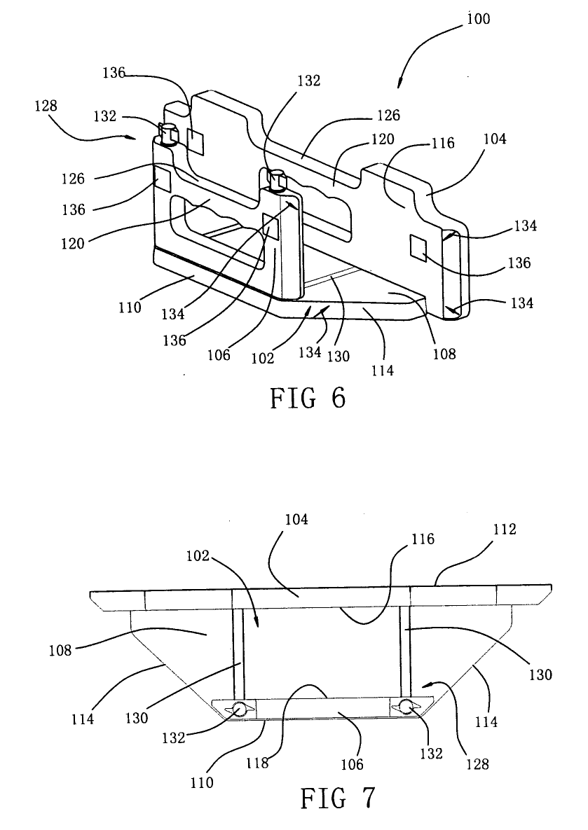

As shown in FIGS. 6 and 7, the stabilizing device 100 comprises a base plate 102, a first supporting wall 104 and a second supporting wall 106. The base plate 102 has a base plane 108, a first side edge 110 and a second side edge 112 which are opposite to and parallel to each other, and two oblique side edges 114. The first supporting wall 104 stands close to the first side edge 110, with two ends thereof preferably located within the oblique side edges 114 of the base plate, and the first supporting wall 104 having a first supporting surface 116 substantially perpendicular to the base plane 108. The second supporting wall 106 stands close to the second side edge 112 of the base plate 102, and has a second supporting surface 118 substantially perpendicular to the base plane 108 and parallel to the first supporting surface 116. Two ends of the second supporting wall 106 are preferably located within the oblique side edges 114 of the base plate. With such a configuration, the supporting walls will hardly get cut even if the saw blade is close to the oblique side edges 114 during cutting. In addition, the first supporting wall 104 and the second supporting wall 106 have substantial similar heights, and each has a handle 120 and a top recess 126. The heights of the first supporting wall 104 and the second supporting wall 106 are preferably adapted to be able to hold therebetween a crown molding 10 with a relatively large width. The recess 126 allows the operator to hold a crown molding with small width to ensure that such crown molding will be well stabilized as well. The handle 120 allows the stabilizing device 100 to be convenient for carrying.

The stabilizing device 100 further comprises an adjusting device 128 acting between the base plate 102 and the second supporting wall 106, for adjusting the position of the second supporting wall 106 on the base plane 108 so that the second supporting wall 106 is movable and can be fixed on a position between the first supporting wall 104 and the second side edge 112 of the base plate 102, for stabilizing crown moldings with different width.

Besides the aforesaid way, the adjusting device 128 may also act between the base plate 102 and the first supporting wall 104 for adjusting the position of the first supporting wall 104; the adjusting device 128 may even act simultaneously between the base plate 102 and the first supporting wall 104 and between the base plate 102 and the second supporting wall 106.

In this embodiment, the adjusting device 128 comprises two parallel slide rails 130 on the base plate 102, and two bolts 132 fix on the second supporting wall 106 and pass through the slide rails 130 (not clearly shown). As the bolts 132 are guided by the slide rails 130, the second supporting wall 106 is movable along the slide rails 130. The bolts 132 are also used to fix the second supporting wall 106 on a desired position. Such a mechanism, slide along a guide rail, and then be fixed at a certain position, is widely used in the mechanical field. The adjusting device 128 of the present invention is not limited to such mechanism.

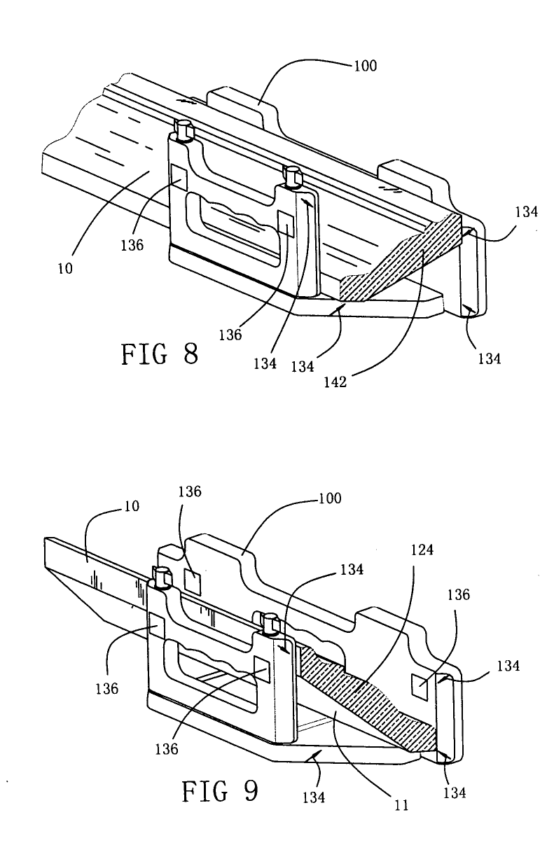

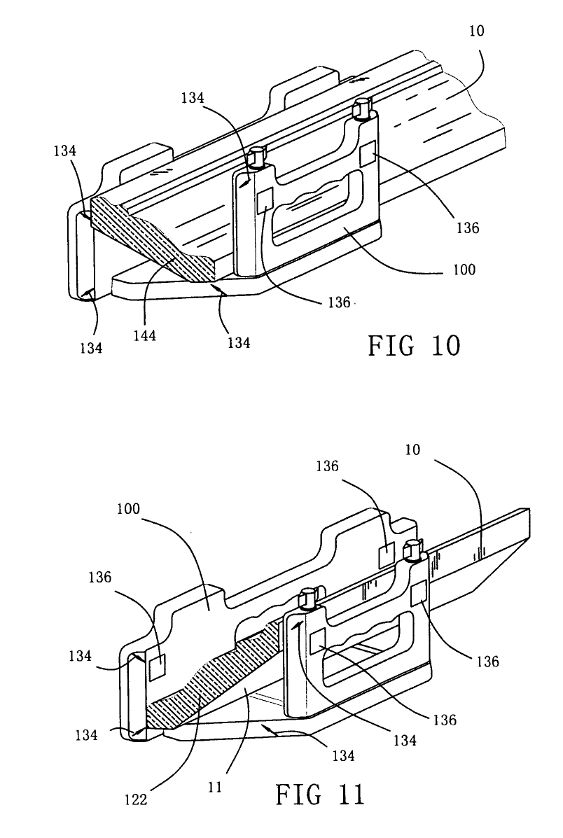

FIGS. 8 to 11 show cutting results of a crown molding 10 that may achieve when it is positioned on a stabilizing device 100 in various ways. Any type of desired joint surfaces can be cut by a vertical cutting, thereby cut efficiency greatly improved. Other advantages of the method of using the stabilizing device 100 will become apparent after considering the following description.

In order to clearly show the cutting results corresponding to the positions where the crown molding 10 is placed on the stabilizing device 100, there are four pairs of markings 134 provided on the stabilizing device 100 according to this embodiment, for indicating the positions how the crown molding 10 should be placed on the stabilizing device 100. It is preferred that the markings 134 are different from each other, each of which clearly indicates the cutting result may be achieved by a respective positioning way. For example, to add words with markings 134, such as RI, RO, LI, LO respectively represents a position in which a right inside-corner joint surface, a right outside-corner joint surface, a left inside-corner joint surface and a left outside-corner joint surface can be cut. Besides, different colors may be used to differentiate each marking 134, and explain in the operation manual or on the stabilizing device 100 what the each color represents. On the other hand, labels 136 may be stuck on the stabilizing device 100, preferably close to the oblique side edges 114, for respectively illustrating the cutting results correspond to the markings 134 with words or drawings. With such provisions, it is very easy and clear for an operator to cut joint surfaces of any type.

The most important advantage of the stabilizing device of the invention is that cutting of four types of joint surfaces of a crown molding may be performed on one side of the saw blade, while it's impossible before the present invention. In the prior art, cutting of the four types of joint surface should be performed on both sides of the saw blade. It is uncomfortable for a right-handed operator to control a saw blade with left hand to perform cutting with the crown molding placed on the right side of the saw blade. Similarly, a left-handed operator may also feel very uncomfortable and easy to be tired when he has to control a saw blade with right hand with the crown molding placed on the left side of the saw blade. Besides, it's very inconvenient to carry a crown molding with a longer length from one side of the saw blade to the other side, and also it is likely to make an operator confused.

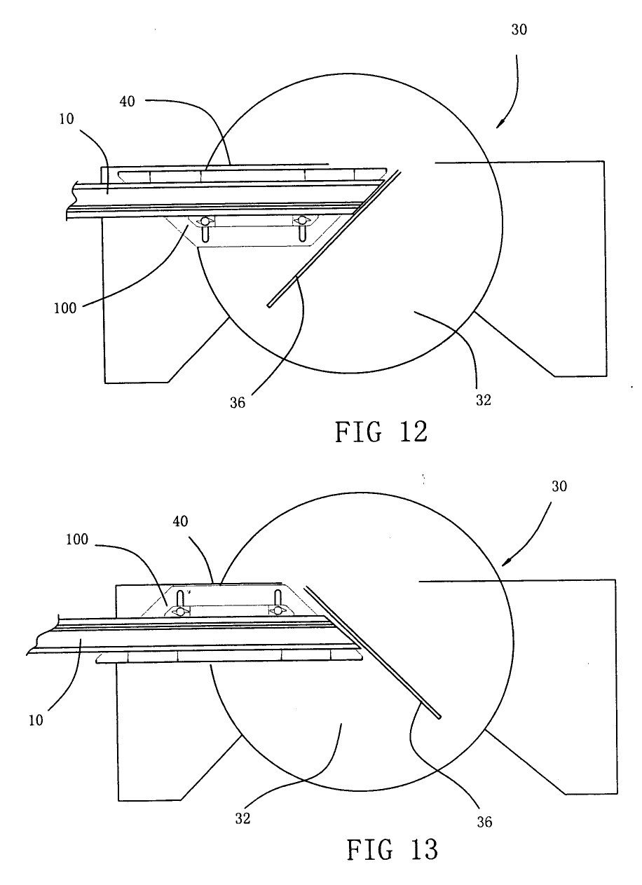

The present invention also provides a method of using the stabilizing device as mentioned hereinabove, the cutting of four types of joint surface may be performed on one side of the saw blade, which overcomes all those disadvantages. The method will be described below with referring to FIG. 12 and FIG. 13, and take a right-handed operation as an example.

Provide a miter saw 30, which comprises a turntable 32, a fence 40 and a saw blade 36. Place a stabilizing device 100 on the miter saw 30 on left side of the saw blade 36, with the base plate 102 lying on the turntable 32, with the first supporting wall 104 or the first side edge 110 of the base plate 102 abutting the fence 40. And then, place a workpiece, i.e. a crown molding 10, on the base plate 102 between the first supporting wall 104 and the second supporting wall 106, with one side of the crown molding 10 leaning against a first supporting surface 116 or a second supporting surface 118, with the other side thereof being supported on the base plane 108, with a main plane 11 of the crown molding 10 inclined to the base plane 108. After that, adjust the adjusting device 128 to stabilize the crown molding 10 between the first supporting wall 104 and the second supporting wall 106. Then, turn the turntable 32 of the miter saw 30 to a miter position where the saw blade 36 forms a first predetermined angle with the fence 40, as shown in FIG. 12. The predetermined angle is typically 45 degrees. At that time, the saw blade 36 is almost parallel to the oblique side edge 114 of the stabilizing device 100. And then the crown molding 10 can be cut.

If it is required to cut the crown molding 10 along another oblique side edge 114, unclamp the crown molding 10, move the stabilizing device 100 to a position that the second supporting wall 106 or the second side edge 112 of the base plate 102 abuts the fence 40 with the stabilizing device 100 still sitting on the left side of the saw blade 36. Place the crown molding 10 between the first supporting wall 104 and the second supporting wall 106 with one side of the crown molding 10 leaning against the first supporting surface 116 or the second supporting surface 118, with the other side thereof being supported on the base plane 108, and with the main plane 11 of the crown molding 10 inclined to the base plane 108. After that, adjust the adjusting device 128 fix clamp the crown molding 10 between the first supporting wall 104 and the second supporting wall 106. Turn the turntable 32 of the miter saw 30 so that the saw blade 36 forms a second predetermined angle with the abutting fence 40, as shown in FIG. 13. The first predetermined angle is substantially equal to the second predetermined angle in degrees, but is different in directions. At that time, the saw blade 36 is almost parallel to another oblique side edge 114 of the stabilizing device 100. And then, the crown molding 10 can be cut.

In the above operation, may also firstly place the stabilizing device 100 with the second supporting wall 106 or the second side edge 112 of the base plate 102 abutting the fence 40, and then perform cutting.

The using method for a left-handed operation is essentially similar to the method described hereinabove, and it is only needed to place the stabilizing device 100 on the right side of the saw blade.

The forgoing discloses and describes only exemplary embodiments of the present invention for purposes of illustration, not for limiting the scope of the present invention. Various modifications and variations can be made without departing from the scope and spirit of the present invention. The invention should only be limited as in the claims appended below.

What is claimed is:

1. A device for stabilizing a workpiece that is to be cut by a circular saw, comprising:
a base plate, which comprises a base plane, a first side edge, a second side edge, and two oblique side edges, wherein the first side edge and the second side edge of the base plate being substantially parallel to each other,
a first supporting wall standing upwardly from the base plate, and being close to the first side edge of the base plate with two ends thereof located within the oblique side edges of the base plate, the first supporting wall having a first supporting surface substantially perpendicular to the base plane and parallel to the first side edge of the base plate;
a second supporting wall standing upwardly from the base plate, and being close to the second side edge of the base plate with two ends thereof located within the oblique side edges of the base plate, the second supporting wall having a second supporting surface substantially perpendicular to the base plane and parallel to the first supporting surface;
an adjusting device disposed between the base plate and the second supporting wall for adjusting the position of the second supporting wall on the base plane so that the second supporting wall being movable and being able to be fixed between the first supporting wall and the second side edge of base plate;
wherein said first supporting surface is substantially equal to said second supporting surface in height.

2. A stabilizing device as claimed in claim 1, wherein said adjusting device comprising at least one slide rail and at least one locking means.

3. A stabilizing device as claimed in claim 1, wherein at least one of the first supporting wall and the second supporting wall defining a handle for holding thereon.

4. A stabilizing device as claimed in claim 1, wherein said base plane is trapezoid shaped.

5. A stabilizing device as claimed in claim 1, wherein four pairs of markings provided on said first supporting wall, said second supporting wall and said base plate for guiding how the workpiece should be positioned for cutting.

6. A stabilizing device as claimed in claim 5, wherein said four pairs of markings are shown in different ways so as to be distinct from each other.

7. A stabilizing device as claimed in claim 5, wherein labels being mounted adjacent to the oblique side edges for indicating cutting results achievable when the workpiece being oriented according to the four pairs of markings.

8. A method for cutting either one or two crown moldings which having a first side and a second side, including the following steps:
providing a miter saw which comprising a turntable, a fence and a saw blade;
providing a stabilizing device which comprising:
a base plate, which comprises a base plane, a first side edge, a second side edge, and two oblique side edges, wherein the first side edge and the second side edge of the base plate being substantially parallel to each other,
a first supporting wall standing upwardly from the base plate, and being close to the first side edge of the base plate with two ends thereof located within the oblique side edges of the base plate, the first supporting wall having a first supporting surface substantially perpendicular to the base plane and parallel to the first side edge of the base plate;
a second supporting wall standing upwardly from the base plate, and being close to the second side edge of the base plate with two ends thereof located within the oblique side edges of the base plate, the second supporting wall having a second supporting surface substantially perpendicular to the base plane and parallel to the first supporting surface;
an adjusting device disposed between the base plate and the second supporting wall for adjusting the position of the second supporting wall on the base plane so that the second supporting wall being movable and being able to be fixed between the first supporting wall and the second side edge of base plate;
placing the stabilizing device on the miter saw, with the base plate thereof sitting on the turntable of the miter saw and either the first supporting wall or the first side edge of the base plate abutting the fence;
placing a workpiece on said base plate with the first side leaning against either the first supporting wall or the second supporting wall, with the second side being supported on the base plane;
adjusting the adjusting device to fix the workpiece between the first supporting wall and the second supporting wall;
rotating the turntable of the miter saw so that the saw blade forms a first predetermined angle with the fence;
cutting the workpiece with the saw blade;
unclamping the workpiece;
moving the stabilizing device to a position where either the second supporting wall or the second side edge of the base plate abutting the fence;
placing the workpiece or another workpiece on the stabilizing device with the first side leaning against either the first supporting wall or the second supporting wall, with the second side being supported on the base plane;
adjusting the adjusting device to fix the workpiece between the first supporting wall and the second supporting wall;
rotating the turntable of the miter saw so that a second predetermined angle being formed between the saw blade and the fence, wherein,
cutting the workpiece with the saw blade.

9. A method for cutting either one or two crown moldings according to claim 8, wherein the first predetermined angle being substantially equal to the second predetermined angle in degrees, and being different in directions.
